(19) United States
(12) Patent Application Publication
(10) Pub. No.: US 2007/0140497 A1
(43) Pub. Date: Jun. 21, 2007

(54) METHOD AND APPARATUS TO PROVIDE ACTIVE AUDIO MATRIX DECODING

(76) Inventors: Han-gil Moon, Seoul (KR); Manish Arora, Suwon-si (KR)

Correspondence Address: STANZIONE & KIM, LLP, 919 18TH STREET, N.W., SUITE 440, WASHINGTON, DC, 20006, US

(21) Appl. No.: 11/535,234

(22) Filed: Sep. 26, 2006

(30) Foreign Application Priority Data
Dec. 19, 2005 (KR) 2005-125452

(51) Int. Cl. H04R 5/00

(52) U.S. Cl. 381/20; 381/22

(57) ABSTRACT

An active audio matrix decoding method and apparatus to generate multi-channel audio signals from a stereo channel audio signal. The method includes: decoding a stereo channel audio signal into a multi-channel signal, extracting a power vector of each channel signal by multiplying a magnitude of each decoded channel signal by positions of a plurality of channel speakers, extracting a vector of a virtual sound source existing between each channel by linearly combining power vector values of each decoded channel, extracting a vector value of a dominant sound image by linear combination of the vectors of the extracted virtual sound sources and normalizing the position of each channel speaker with respect to the vector value of the dominant sound image, and distributing a gain value to each channel position by comparing the magnitude of an entire decoded channel signal with the magnitude of each channel signal.

### CROSS-REFERENCE TO RELATED APPLICATIONS

This application claims the benefit of Korean Patent Application No. 10-2005-0125452, filed on Dec. 19, 2005, in the Korean Intellectual Property Office, the disclosure of which is incorporated herein in its entirety by reference.

### BACKGROUND OF THE INVENTION

1. Field of the Invention

The present general inventive concept relates to an audio reproducing system, and more particularly, to an active audio matrix decoding method and apparatus to generate a multi-channel audio signal from a stereo-channel audio signal.

2. Description of the Related Art

Generally, when movies are watched at home, ground wave broadcasting has been the main source of these movies in the past. However, video tapes, video discs, and satellite broadcasting have recently gained popularity and widespread use. Accordingly, original sound of movies can be enjoyed at home. In the video tapes, video discs, and satellite broadcastings which provide the original sound, a multi-channel audio signal is encoded into a 2-channel audio signal through matrix processing. Also, the 2-channel audio signal encoded through the matrix processing can be reproduced as a stereo signal. Furthermore, when a dedicated decoder is used, a 5-channel audio signal, including a front left (L) channel, a center (C) channel, a front right (R) channel, a left surround (Ls) channel, and a right surround (Rs) channel, is restored. In this 5-channel audio signal, the center channel signal plays a role in obtaining a correct localization that is for clearness of sound, and the surround channel signal(s) improve the actual feeling or perception of moving sound, environment sound, and echo sound.

A generally used matrix decoder generates a center channel and a surround channel by using a sum and a difference of two channel signals. An audio matrix in which matrix characteristics are not changed is known as a passive matrix decoder.

In each channel signal separated by the passive matrix decoder, when encoding is performed, other channel audio signals are scaled down and linearly combined together. Accordingly, the separation between the channels is low in the channel signals output through the conventional passive matrix decoder such that sound localization is not performed clearly. An active matrix decoder adaptively changes the matrix characteristics in order to improve separation among 2-channel matrix encoding signals.

U.S. Pat. No. 4,779,260 filed Feb. 6, 1986 entitled a ‘variable matrix decoder,’ and WO 02/19768 A 2 filed Aug. 31, 2000, entitled a ‘method and apparatus for audio matrix decoding’ describe a conventional matrix decoder.

FIG. 1 illustrates the conventional matrix decoder. In the conventional matrix decoder, gain function units 210′ and 216 clip an input signal in order to balance levels of a stereo signal (Rt, Lt). A passive matrix function unit 220′ outputs a passive matrix signal from the stereo signal (R't, L't) output from the gain function units 210′ and 216. The passive matrix function unit 220′ also includes scaling function units 222 and 224, and combining function units 226 and 228. A variable gain signal generation unit 230′ generates 6 control signals (gL, gR, gF, gB, gLB, gRB) in response to the passive matrix signal generated in the passive matrix function unit 220′. A matrix coefficient generation unit 232 generates 12 matrix coefficients in response to the 6 control signals generated in the variable gain signal generation unit 230′. An adaptive matrix function unit 214 generates output signals (L, C, R, L, Ls, Rs) in response to the input stereo signal (R't, L't) and the matrix coefficients generated in the matrix coefficient generation unit 232. The variable gain signal generation unit 230′ monitors the level of each channel signal, and by calculating an optimum linear coefficient value with respect to the level of the monitored channel signal, reconstructs a multi-channel audio signal. The matrix coefficient generation unit 232 nonlinearly increases the level of a channel having a highest level.

However, the conventional matrix decoder illustrated in FIG. 1 does not consider positions of virtual sound sources generated in a multi-channel environment such that localization of a sound image cannot be performed accurately. Also, since it is difficult to express a positional change of a sound source moving in a virtual space, the capability of dynamically expressing a sound image is insufficient.

### SUMMARY OF THE INVENTION

The present general inventive concept provides an active audio matrix decoding method and apparatus by which a stereo audio signal is matrix decoded into a multi-channel audio signal and a level of each channel audio signal is tuned to an optimum based on a position of a virtual sound source.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing an audio matrix decoding method of generating a multi-channel audio signal from a stereo-channel audio signal, the method including decoding the stereo-channel audio signal into a multi-channel signal, extracting a power vector of each channel signal by multiplying a magnitude of each decoded channel signal by positions of a plurality of channel speakers, extracting a vector of a virtual sound source existing between each channel by linearly combining power vector values of respective decoded channels, extracting a vector value of a dominant sound image by linearly combining the vectors of the extracted virtual sound sources and normalizing the position of each channel speaker with respect to the vector value of the dominant sound image, and distributing a gain value to the position or each channel speaker by comparing the magnitude of an entire decoded channel signal including all the decoded channel signals with the magnitude of each individual channel signal.

The foregoing and/or other aspects of the present general inventive concept are also achieved by providing an audio matrix decoding method, including passively decoding two channel signals into multi-channel signals, and adjusting characteristics of the multi-channel signals based on corresponding power vectors of the decoded multi-channel signals, positions of channel speakers corresponding to the multi-channel signals, and characteristics of virtual sound source vectors derived from the power vectors.

The foregoing and/or other aspects of the present general inventive concept are also achieved by providing an audio matrix decoding apparatus, including a passive decoding unit to decode two channel signals into multi-channel signals, and an active decoding unit to adjust characteristics of the multi-channel signals based on corresponding power vectors of the decoded multi-channel signals, positions of channel speakers corresponding to the multi-channel signals, and characteristics of virtual sound source vectors derived from the power vectors.

The foregoing and/or other aspects of the present general inventive concept are also achieved by providing an audio matrix decoding apparatus to generate a multi-channel audio signal from a stereo-channel audio signal, the apparatus including a passive decoder unit to decode the stereo-channel audio signal into a multi-channel signal through linear combination of channels, and an active decoder unit to extract a power vector of each channel signal by multiplying a magnitude of each channel signal decoded by the passive decoder unit by positions of a plurality of channel speakers, to extract a vector of a virtual sound source existing between each channel from power vector values of respective channels, to extract a global vector indicating a position and magnitude of a dominant sound image by linearly combining the virtual sound source vectors, to normalize the position of each channel speaker with respect to the position of the dominant sound image, and to distribute the magnitude of each channel signal according to a ratio of the magnitude of each individual channel signal to a magnitude of an entire decoded channel signal including all the decoded channel signals.

The foregoing and/or other aspects of the present general inventive concept are also achieved by providing an audio matrix decoding apparatus to generate a multi-channel audio signal from a stereo-channel audio signal, the apparatus including a passive matrix decoder unit to decode the stereo-channel audio signal into a multi-channel signal through linear combination of channels, a channel power vector extraction unit to extract a power vector of each channel signal by multiplying a magnitude of each channel signal decoded in the passive matrix decoder unit by positions of a plurality of channel speakers, a virtual sound source power vector estimation unit to extract a vector of a virtual sound source existing between each channel from power vector values of respective channels extracted from the channel power vector extraction unit, a global vector extraction unit to extract a global vector indicating a position and magnitude of a dominant sound image by linearly combining the virtual sound source vectors estimated in the virtual sound source power vector estimation unit, a channel selection unit to normalize the position of each channel speaker with respect to the position of the dominant sound image estimated in the global vector extraction unit, and a channel power distribution unit to distribute the magnitude of each channel signal according to a ratio of the magnitude of each individual channel signal to a magnitude of an entire decoded channel signal including all of the decoded channel signals.

The foregoing and/or other aspects of the present general inventive concept are also achieved by providing a computer readable medium containing executable code to perform an active audio matrix decoding, the medium including executable code to perform a passive decoding operation on two channel signals to determine multi-channel signals, and executable code to redistribute the decoded multi-channel signals according to positions of corresponding channel speakers and characteristics of the multi-channel signals.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 illustrates a conventional matrix decoder;

FIG. 2 is a block diagram illustrating an active audio matrix decoding apparatus according to an embodiment of the present general inventive concept;

FIG. 3 illustrates redistribution of energy with respect to positions of each channel speaker and virtual sound sources according to an embodiment of the present general inventive concept;

FIG. 4 illustrates a passive matrix decoder unit of the active audio matrix decoding apparatus of FIG. 2, according to an embodiment of the present general inventive concept;

FIG. 5 illustrates a channel power vector extraction unit of the active audio matrix decoding apparatus of FIG. 2, according to an embodiment of the present general inventive concept;

FIG. 6 illustrates a virtual sound source power vector estimation unit of the active audio matrix decoding apparatus of FIG. 2, according to an embodiment of the present general inventive concept;

FIG. 7 illustrates a global power vector extraction unit of the active audio matrix decoding apparatus of FIG. 2, according to an embodiment of the present general inventive concept;

FIG. 8 illustrates a channel selection unit of the active audio matrix decoding apparatus of FIG. 2, according to an embodiment of the present general inventive concept;

FIG. 9 illustrates a channel power distribution unit of the active audio matrix decoding apparatus of FIG. 2, according to an embodiment of the present general inventive concept; and

FIG. 10 is a flowchart illustrating a method of audio matrix decoding according to an embodiment of the present general inventive concept.

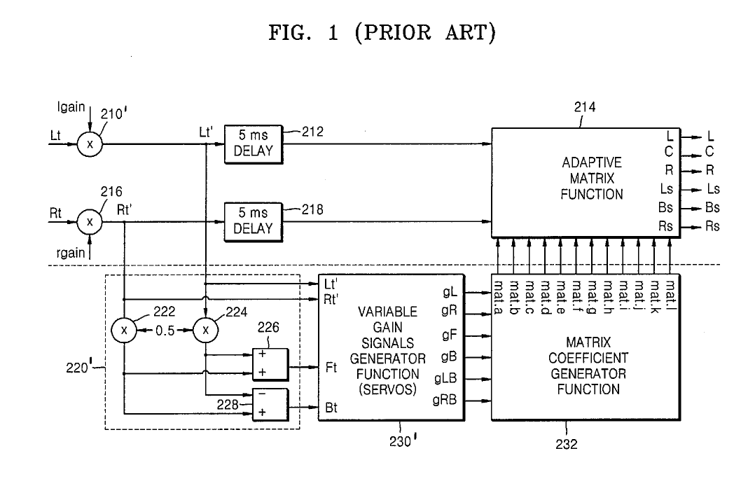

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

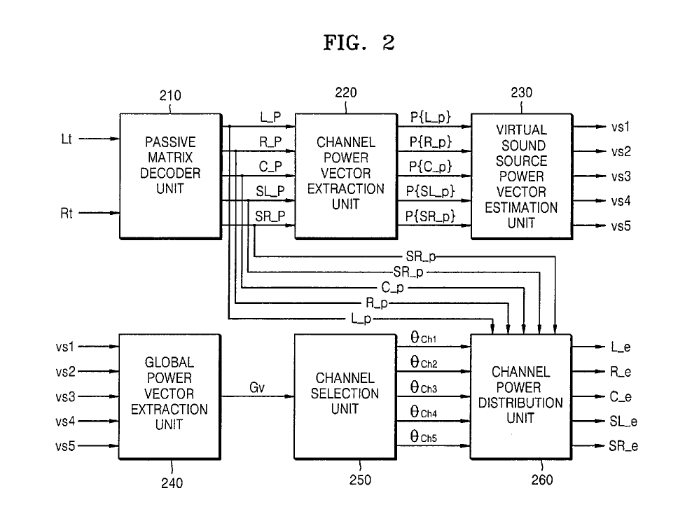

FIG. 2 is a block diagram illustrating an active audio matrix decoding apparatus according to an embodiment of the present general inventive concept.

The active audio matrix decoding apparatus of FIG. 2 includes a passive matrix decoder unit 210, a channel power vector extraction unit 220, a virtual sound source power vector estimation unit 230, a global power vector extraction unit 240, a channel selection unit 250, and a channel power distribution unit 260.

First, a signal providing apparatus (not illustrated) receives a signal from a video tape, a video disc, or satellite broadcasting, and reproduces a video signal and an audio signal. The audio signal is a matrix-encoded two-channel stereo signal. The video signal is then provided to a monitor (not illustrated).

The passive matrix decoder unit 210 decodes the matrix-encoded stereo signal (Lt, Rt) into a left channel signal (L_p), a center channel signal (C_p), a right channel signal (R_p), a left surround channel signal (SL_p), and a right surround channel signal (SR_p) through linear combination.

The channel power vector extraction unit 220 extracts 5 channel power vectors (P{L_p}, P{C_p}, P{R_p}, P{SL_p}, P{SR_p}) by multiplying a magnitude of each of the channel signals (L_p, C_p, R_p, SL_p, SR_p) decoded by the passive matrix decoder unit 210 by a position value of a speaker in the form of polar coordinates.

From the power vectors of the respective channels (P{L_p}, P{C_p}, P{R_p}, P{SL_p}, P{SR_p}), the virtual sound source vector estimation unit 230 calculates virtual sound source vectors (vs1, vs2, vs3, vs4, vs5) existing between each channel.

The global power vector extraction unit 240 extracts a global power vector (Gv) through linear combination of the virtual sound source vectors (vs1, vs2, vs3, vs4, vs5) calculated by the virtual sound source power vector estimation unit 230 and identifies a position and a magnitude of a sound image that is the most dominant from among an entire sound image. The global power vector (Gv) may be a sum of the virtual sound source vectors (vs1, vs2, vs3, vs4, vs5).

The channel selection unit 250 normalizes a speaker position of each channel relative to the position of the dominant sound image corresponding to the global power vector (Gv) extracted by the global vector extraction unit 240. That is, in order to improve the gain of a signal, the channel selection unit 250 selects channels to be output.

The channel power distribution unit 260 adjusts a signal gain of each channel by comparing the magnitude of each channel signal (L_p, C_p, R_p, SL_p, SR_p) decoded in the passive matrix decoder unit 210 with the magnitude of an entire channel signal (Lp²+R_p²+C_p²+SL_p²+SR_p²) including all the decoded channel signals, and redistributes the adjusted signal gain to the position of each channel normalized by the channel selection unit 250. Accordingly, the channel power distribution unit 260 outputs signals in which gains are redistributed for each channel (L_e, R_e, C_e, SL_e, SR_e). The passive matrix decoder unit 210 may be a passive decoding unit while the channel power vector extraction unit 220, the virtual sound source power vector estimation unit 230, the global power vector extraction unit 240, the channel selection unit 250, and the channel power distribution unit 260 may collectively be an active decoding unit.

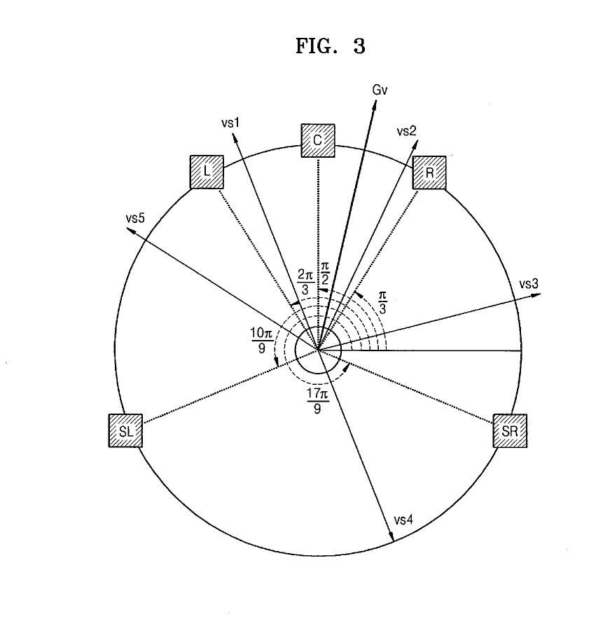

FIG. 3 illustrates redistribution of energy of each channel (e.g., by adjusting the gain) with respect to the positions of each channel speaker and the virtual sound sources according to an embodiment of the present general inventive concept.

Referring to FIG. 3, each position of left, center, right, left surround, and right surround channel speakers (L, C, R, SL, SR) is expressed in polar coordinates. Also, the virtual sound source vectors (vs1, vs2, vs3, vs4, vs5) exist between each channel speaker. The global power vector (Gv) indicates the position of the sound image most dominant from among all the sound images (i.e., an entire sound image). In other words, the global power vector (Gv) may be a sum of all the virtual sound source vectors (vs1, vs2, vs3, vs4, vs5). Accordingly, a signal level adjusted by a gain adjusting function is redistributed to the position of each channel speaker normalized based on the global power vector (Gv).

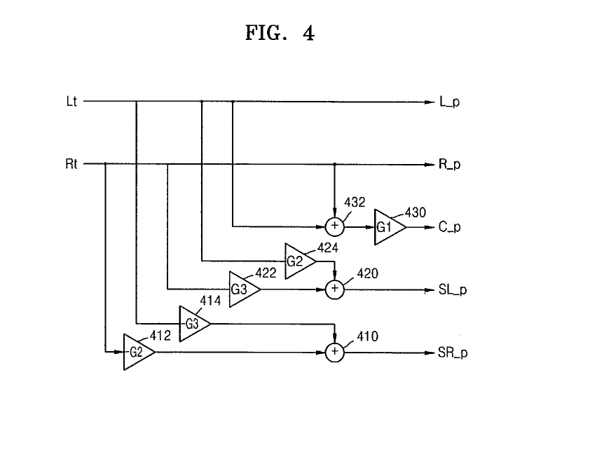

FIG. 4 illustrates the passive matrix decoder unit 210 of FIG. 2 according to an embodiment of the present general inventive concept. The matrix-encoded stereo signal (Lt, Rt) is decoded into 5 channel audio signals (L_p, C_p, R_p, SL_p, SR_p), including the left, center, right, left surround, and right surround channel audio signals through linear combination using multipliers 412, 414, 422, 424, 432, and 430, and adders 410, 420, and 432. For example, L_p=Lt, R_p=Rt, C_p=0.7*(Lt+Rt), SL_p=−0.866Lt+0.5Rt, SR_p=−0.5Lt+0.866Rt.

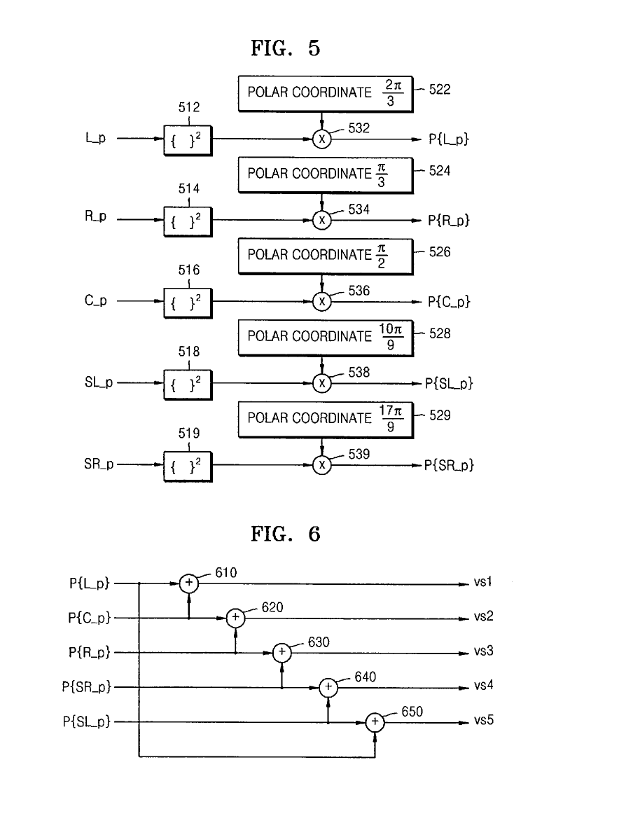

FIG. 5 illustrates the channel power vector extraction unit 220 of FIG. 2 according to an embodiment of the present general inventive concept.

Referring to FIG. 5, first through fifth squaring units 512, 514, 516, 518, and 519 square the left, center, right, left surround, and right surround channel signals (L_p, C_p, R_p, SL_p, SR_p), respectively, decoded by the passive matrix decoder unit 210 and calculate respective power values.

A first multiplier 532 extracts the power vector (P{L_p}) of the left channel by multiplying the power value of the left channel signal L_p calculated by the first squaring unit 512 by a preset polar coordinate value (for example, 120 degrees) of the left channel speaker.

A second multiplier 534 extracts the power vector (P{R_p}) of the right channel by multiplying the power value of the right channel signal R_p calculated by the second squaring unit 514 by a preset polar coordinate value (for example, 60 degrees) of the right channel speaker.

A third multiplier 536 extracts the power vector (P{C_p}) of the center channel by multiplying the power value of the center channel signal C_p calculated by the third squaring unit 516 by a preset polar coordinate value (for example, 90 degrees) of the center channel speaker.

A fourth multiplier 538 extracts the power vector (P{SL_p}) of the left surround channel by multiplying the power value of the left surround channel signal SL_p calculated by the fourth squaring unit 518 by a preset polar coordinate value (for example, 200 degrees) of the left surround channel speaker.

A fifth multiplier 539 extracts the power vector (P{SR_p}) of the right surround channel by multiplying the power value of the right surround channel signal SR_p calculated by the fifth squaring unit 519 by a preset polar coordinate value (for example, 340 degrees) of the left surround channel speaker. The channel power vector extraction unit 220 determines energy components of the decoded channel signals that correspond to a direction or position in which the corresponding channel speaker is arranged. For example, the channel power vector extraction unit 220 determines the energy component of the right surround channel SR_p that corresponds to the direction or position of 17π/9 (340 degrees from center) as the power vector (P{SR_p}) of the right surround channel.

FIG. 6 illustrates the virtual sound source power vector estimation unit 230 of FIG. 2 according to an embodiment of the present general inventive concept.

A first adder 610 extracts a first virtual sound source vector value (vs1) by adding the power vector (P{L_p}) of the left channel and the power vector (P{C_p}) of the center channel.

A second adder 620 extracts a second virtual sound source vector value (vs2) by adding the power vector (P{C_p}) of the center channel and the power vector (P{R_p}) of the right channel.

A third adder 630 extracts a third virtual sound source vector value (vs3) by adding the power vector (P{R_p}) of the right channel and the power vector (P{SR_p}) of the right surround channel.

A fourth adder 640 extracts a fourth virtual sound source vector value (vs4) by adding the power vector (P{SR_p}) of the right surround channel and the power vector (P{SL_p}) of the left surround channel.

A fifth adder 650 extracts a fifth virtual sound source vector value (vs5) by adding the power vector (P{SL_p}) of the left surround channel and the power vector (P{L_p}) of the left channel.

FIG. 7 illustrates the global power vector extraction unit 240 of FIG. 2 according to an embodiment of the present general inventive concept.

The first through fifth virtual sound source vector values (vs1, vs2, vs3, vs4, vs5) are linearly combined by adders 710, 720 and 730 to generate the global vector (Gv). This global vector (Gv) indicates the position and the magnitude of the sound image that is the most dominant from among all the sound images.

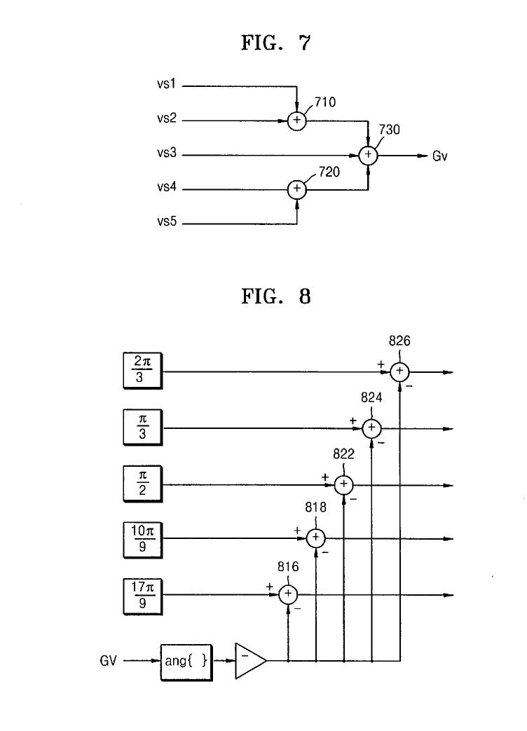

FIG. 8 illustrates the channel selection unit 250 of FIG. 2 according to an embodiment of the present general inventive concept.

A first subtracter 826 obtains a speaker position (θ_{Ch1}) of the normalized left channel by subtracting the position value of the global vector (Gv) from the position value of the left channel speaker.

A second subtracter 824 obtains a speaker position (θ_{Ch2}) of the normalized right channel by subtracting the position value of the global vector (Gv) from the position value of the right channel speaker.

A third subtracter 822 obtains a speaker position (θ_{Ch3}) of the normalized center channel by subtracting the position value of the global vector (Gv) from the position value of the center channel speaker.

A fourth subtracter 818 obtains a speaker position (θ_{Ch4}) of the normalized left surround channel by subtracting the position value of the global vector (Gv) from the position value of the left surround channel speaker.

A fifth subtracter 816 obtains a speaker position (θ_{Ch5}) of the normalized right surround channel by subtracting the position value of the global vector (Gv) from the position value of the right surround channel speaker.

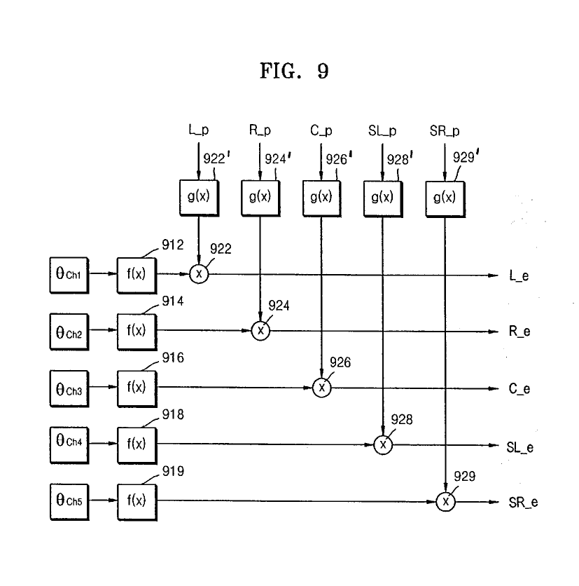

FIG. 9 illustrates the channel power distribution unit 260 of FIG. 2 according to an embodiment of the present general inventive concept.

First through fifth multipliers 922, 924, 926, 928, and 929 output redistributed channel signals (L_e, R_e, C_e, SL_e, SR_e), respectively, by multiplying disposition functions f(x) 912, 914, 916, 918, and 919 having the position values (θ_{Ch1}, θ_{Ch2}, θ_{Ch3}, θ_{Ch4}, θ_{Ch5}) of the normalized channels as parameters by gain adjusting functions g(x) 922′, 924′, 926′, 928′, and 929′, respectively, having the magnitude values (L_p, R_p, C_p, SL_p, SR_p) of the decoded channel signals as parameters.

The gain adjusting function g(x) compares the magnitude of the entire decoded channel signal (i.e., all the decoded channel signals combined) with the magnitude of each individual channel signal, and adjusts the magnitude of each individual channel signal according to a ratio of the magnitude of each channel signal to the magnitude of the entire channel signal. For example, if the magnitude of the right channel signal (R_p) is equal to or greater than 20% of the magnitude of the entire channel signal (L_p²+R_p²+C_p²+SL_p²+SR_p²), the magnitude (R_p) of the right channel signal is increased in proportion to a logarithmic function.

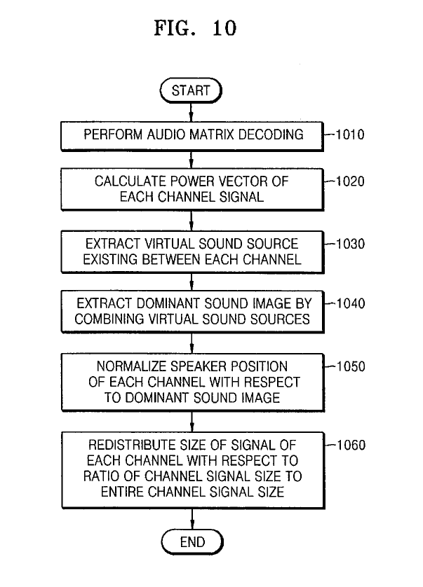

FIG. 10 is a flowchart illustrating a method of audio matrix decoding according to an embodiment of the present general inventive concept. The method of FIG. 10 may be performed by the active audio matrix decoding apparatus of FIG. 2.

First, a matrix-encoded stereo signal is decoded into a multi-channel signal through a passive matrix decoding algorithm in operation 1010.

Then, a power vector of each decoded channel signal is calculated by multiplying a magnitude of each decoded channel signal by a position of a plurality of channel speakers in operation S1020.

The vector of a virtual sound source existing between each channel is extracted in operation 1030 by linearly combining the power vector of each decoded channel together with an adjacent decoded channel signal.

A global vector indicating a position of a dominant sound image is calculated and a position of each channel speaker is normalized with respect to the position of the dominant sound image in operation 1050 by linearly combining the extracted vectors of the virtual sound sources.

The magnitude of the entire decoded channel signal is compared with the magnitude of each channel signal such that the magnitude of each channel signal is adjusted according to a ratio of the magnitude of each channel signal to the magnitude of the entire channel signal. Accordingly, the magnitude of the signal (energy) adjusted in each channel is redistributed to the position of each channel speaker in operation 1060.

The present general inventive concept can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

According to the embodiments of the present general inventive concept as described above, a level of each channel signal can be tuned optimally based on a position of a virtual sound source generated by considering an actual environment. Accordingly, limits of a conventional matrix decoder, i.e., a low separation due to high correction necessarily occurring between channels can be solved psycho acoustically.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An audio matrix decoding method of generating a multi-channel audio signal from a stereo-channel audio signal, the method comprising:
decoding the stereo-channel audio signal into a multi-channel signal;
extracting a power vector of each channel signal by multiplying a magnitude of each decoded channel signal by positions of a plurality of channel speakers;
extracting a vector of a virtual sound source existing between each channel by linearly combining power vector values of respective decoded channels;
extracting a vector value of a dominant sound image by linearly combining the vectors of the extracted virtual sound sources and normalizing the position of each channel speaker with respect to the vector value of the dominant sound image; and
distributing a gain value to the position of each channel speaker by comparing the magnitude of an entire decoded channel signal with the magnitude of each channel signal.

2. The method of claim 1, wherein the extracting of the power vector comprises:
calculating power value by squaring each decoded channel signal; and
calculating the power vector of each channel signal by multiplying a position vector of each channel speaker in the form of polar coordinates by the calculated power value.

3. The method of claim 1, wherein the extracting of the vector of the virtual sound source comprises adding the power vector value of a predetermined channel to the power vector value of a channel adjacent to the predetermined channel.

4. The method of claim 1, wherein the calculating of the normalized position values comprises:
calculating the vector of the dominant sound image by linearly combining the extracted vectors of the virtual sound sources; and
calculating a normalized position value of each channel speaker by subtracting the position of the dominant sound image from the position of the channel speaker.

5. The method of claim 1, wherein the distributing of the gain value comprises:
comparing the magnitude of an entire decoded channel signal including all the decoded channel signals with the magnitude of each individual channel signal and adjusting the magnitude of each channel signal according to a ratio of the magnitude of each individual channel signal to the magnitude of the entire decoded channel signal; and
multiplying the magnitude of the signal adjusted in each channel by the position value of each normalized channel.

6. An audio matrix decoding method, comprising:
passively decoding two channel signals into multi-channel signals; and
adjusting characteristics of the multi-channel signals based on corresponding power vectors of the decoded multi-channel signals, positions of channel speakers corresponding to the multi-channel signals, and characteristics of virtual sound source vectors derived from the power vectors.

7. The audio matrix decoding method of claim 6, wherein the adjusting of the characteristics of the multi-channel signals comprises determining the power vectors of the decoded multi-channel signals by determining an energy component of each of the multi-channel signals that corresponds to an angular direction in which the corresponding channel speakers are arranged.

8. The audio matrix decoding method of claim 6, wherein the adjusting of the characteristics of the multi-channel signals comprises determining the virtual sound source vectors by combining the power vectors of adjacent pairs of the multi-channel signals.

9. The audio matrix decoding method of claim 6, wherein the adjusting of the characteristics of the multi-channel signals comprises determining a global power vector by combining each of the virtual sound source vectors and normalizing the positions of each of the channel speakers based on a comparison of the global power vector and the positions of each of the channel speakers.

10. The audio matrix decoding method of claim 9, wherein the adjusting of the characteristics of the multi-channel signals comprises determining the normalized positions of the channel speakers by subtracting an angular position of the global power vector from each of the positions of the channel speakers.

11. The audio matrix decoding method of claim 9, wherein the adjusting of the characteristics of the multi-channel signals further comprises:
comparing a magnitude of each of the individual multi-channel signals with a magnitude of a combination of the multi-channel signals to determine corresponding gain adjustment amounts; and
adjusting the gains of the multi-channel signals by the corresponding gain adjustment amounts, and repositioning the gain adjusted multi-channel signals based on the normalized positions of the corresponding channel speakers.

12. An audio matrix decoding apparatus, comprising:
a passive decoding unit to decode two channel signals into multi-channel signals; and
an active decoding unit to adjust characteristics of the multi-channel signals based on corresponding power vectors of the decoded multi-channel signals, positions of channel speakers corresponding to the multi-channel signals, and characteristics of virtual sound source vectors derived from the power vectors.

13. The audio matrix decoding apparatus of claim 12, wherein the active decoding unit determines the power vectors of the decoded multi-channel signals by determining an energy component of each of the multi-channel signals that corresponds to an angular direction in which the corresponding channel speakers are arranged.

14. The audio matrix decoding apparatus of claim 12, wherein the active decoding unit determines the virtual sound source vectors by combining the power vectors of adjacent pairs of the multi-channel signals.

15. The audio matrix decoding apparatus of claim 12, wherein the active decoding unit determines a global power vector by combining each of the virtual sound source vectors and normalizing the positions of each of the channel speakers based on a comparison of the global power vector and the positions of each of the channel speakers.

16. The audio matrix decoding apparatus of claim 15, wherein the active decoding unit determines the normalized positions of the channel speakers by subtracting an angular position of the global power vector from each of the positions of the channel speakers.

17. The audio matrix decoding apparatus of claim 15, wherein the active decoding unit compares a magnitude of each of the individual multi-channel signals with a magnitude of a combination of the multi-channel signals to determine corresponding gain adjustment amounts, adjusts the gains of the multi-channel signals by the corresponding gain adjustment amounts, and repositions the gain adjusted multi-channel signals based on the normalized positions of the corresponding channel speakers.

18. The audio matrix decoding apparatus of claim 12, wherein the active decoding unit extracts the power vectors of each channel signal by multiplying a magnitude of each decoded channel signal by positions of the channel speakers, extracts the virtual sound source vector existing between each channel by linearly combining power vector values of respective decoded channels, extracts a vector value of a dominant sound image by linearly combining the vectors of the extracted virtual sound sources and normalizing the position of each channel speaker with respect to the vector value of the dominant sound image, and distributes a gain value to each channel position by comparing the magnitude of an entire decoded channel signal with the magnitude of each channel signal.

19. An audio matrix decoding apparatus to generate a multi-channel audio signal from a stereo-channel audio signal, the apparatus comprising:
a passive decoder unit to decode the stereo-channel audio signal into a multi-channel signal through linear combination of channels; and
an active decoder unit to extract a power vector of each channel signal by multiplying a magnitude of each channel signal decoded by the passive decoder unit by positions of a plurality of channel speakers, to extract a vector of a virtual sound source existing between each channel from power vector values of respective channels, to extract a global vector indicating a position and magnitude of a dominant sound image by linearly combining the virtual sound source vectors, to normalize the position of each channel speaker with respect to the position of the dominant sound image, and to distribute the magnitude of each channel signal according to a ratio of the magnitude of each individual channel signal to a magnitude of an entire decoded channel signal including all the decoded channel signals.

20. An audio matrix decoding apparatus to generate a multi-channel audio signal from a stereo-channel audio signal, the apparatus comprising:
a passive matrix decoder unit to decode the stereo-channel audio signal into a multi-channel signal through linear combination of channels;
a channel power vector extraction unit to extract a power vector of each channel signal by multiplying a magnitude of each channel signal decoded by the passive matrix decoder unit by positions of a plurality of channel speakers;
a virtual sound source power vector estimation unit to extract a vector of a virtual sound source existing between each channel from power vector values of respective channels extracted from the channel power vector extraction unit;
a global vector extraction unit to extract a global vector indicating a position and magnitude of a dominant sound image by linearly combining the virtual sound source vectors estimated by the virtual sound source power vector estimation unit;
a channel selection unit to normalize the position of each channel speaker with respect to the position of the dominant sound image estimated by the global vector extraction unit; and
a channel power distribution unit to distribute the magnitude of each channel signal according to a ratio of the magnitude of each individual channel signal to a magnitude of an entire decoded channel signal including all the decoded channel signals.

21. The apparatus of claim 22, wherein the channel power vector extraction unit comprises:
a squaring unit to calculate each power value by squaring each decoded multi-channel signal; and
a multiplication unit to calculate the power vector of each channel by multiplying the magnitude of each channel signal calculated by the squaring unit by the position value of the corresponding speaker in the form of polar coordinates.

22. The apparatus of claim 21, wherein the virtual sound source power vector estimation unit comprises an adder to add the vector value of a selected channel signal to the vector of a channel adjacent to the predetermined channel.

23. The apparatus of claim 21, wherein the channel selection unit comprises a subtracter to subtract the position of the dominant sound image extracted by the global vector extraction unit from the position value of a selected channel speaker.

24. The apparatus of claim 21, wherein the channel power distribution unit comprises a multiplier to output a redistributed signal of each channel by multiplying a disposition function having the position values of the normalized channels as parameters by a gain adjusting function having the magnitude values of the decoded channel signals as parameters.

25. The apparatus of claim 24, wherein the gain adjusting function increases the magnitude of a selected channel signal if the ratio of the magnitude of the decoded selected channel signal to the magnitude of the entire decoded channel signal is equal to or greater than a predetermine level, and decreases the magnitude of the selected channel signal if the ratio is less than the predetermined level.

26. A computer readable medium containing executable code to perform an active audio matrix decoding, the medium comprising:
executable code to perform a passive decoding operation on two channel signals to determine multi-channel signals; and
executable code to redistribute the decoded multi-channel signals according to positions of corresponding channel speakers and characteristics of the multi-channel signals.
